(19) United States
(12) Patent Application Publication
(10) Pub. No.: US 2007/0215599 A1
(43) Pub. Date: Sep. 20, 2007

(54) Systems and methods for predicting the time to change the temperature of an object

(75) Inventor: Andrew Kahler, Fortson, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: W.C. Bradley Company

(21) Appl. No.: 11/378,748

(22) Filed: Mar. 17, 2006

(51) Int. Cl. H05B 1/02

(52) U.S. Cl. 219/492

(57) ABSTRACT

Systems and methods for estimating the time for the internal temperature of an object to reach a desired temperature are disclosed. One system includes a control unit configured to determine a temperature ratio, the temperature ratio including a relationship between a change of internal temperature of the object from an initial temperature to a temperature measured at an elapsed time and the total internal temperature change needed to reach a reference temperature. The control unit may be further configured to estimate a time remaining for the internal temperature to reach the reference temperature based on a function of the temperature ratio and a time ratio, the time ratio being a relationship between the elapsed time and the total time change for the internal temperature of the object to reach the reference temperature.

### TECHNICAL FIELD

The present disclosure is generally related to predicting the time to change the temperature of an object, and more particularly, is related to systems and methods for predicting the remaining time for an object to reach a desired temperature.

### BACKGROUND

Cooking a food item to a desired temperature can be critical to avoid undercooking or overcooking. Accordingly, cooking thermometers are commonly used to accurately measure and display the current cooking temperature of food items being cooked. For example, the internal temperature of meat can be used to determine the doneness of the meat (i.e. rare, medium, or well done, etc).

Barbecuing and roasting a large cut of meat can present a unique challenge that does not exist when grilling smaller items such as hamburgers, hot dogs, and chicken breasts. For example, large cuts of meat are often cooked at relatively lower temperatures over a long cooking time. Additionally, unlike cooking in a range, the cooking chamber of a barbecue grill or smoker can be difficult to keep at a consistent temperature. Accordingly, it is even more important that meat thermometers be used to check the internal temperature of the meat to ensure that the food is cooked to the desired taste, and more importantly, to assure that any potential bacteria (e.g., salmonella) or parasites (e.g., trichinae) have been killed and the meat is safe to eat.

However, although current meat thermometers can provide the current internal temperature of the food item, they are currently not capable of easily and reliably predicting the remaining cooking time of the food. It is advantageous to know well in advance when a meat item will be finished cooking. For example, the timing of meal preparation such that the entree (e.g., a large meat item) and a variety of side dishes are ready at the same time is important since many dishes are best served within a narrow window of time following their preparation.

Recipes often provide approximate cooking times. However, these approximate cooking times are based upon experimentation under conditions in which the cooking temperature is known and accurately maintained. The cooking time of the food items are also dependent upon the mass (e.g. weight), shape, and size of a food item. For example, the preparer of a meat item may use a chart that indicates an estimated cooking time to achieve a desired cooking temperature for a meat item having a particular mass.

However, these charts are approximate and make assumptions with respect to the shape of the meat and a consistent temperature in the cooking chamber. These assumptions can lead to extremely inaccurate time estimates when barbecuing or smoking. For example, maintaining the exact temperature used by the chart in the cooking chamber is particularly challenging when cooking on barbecue grills, such as charcoal grills, and to a lesser extent, gas grills. Additionally, the shape of two cuts of meat having the same weight can vary substantially and meats having a substantial amount of fat may decrease substantially in weight during the cooking. Furthermore, temperature charts do not take into account the actual initial temperature of a food item, which can change the total cooking time significantly. Thus, the accuracy of any published cooking times can be highly inaccurate even if the weight of the food item is known and the temperature of the cooking chamber can be constantly maintained.

In addition to the inherent potential inaccuracies of using the charts, it can be an inconvenience to determine the weight of the particular food item in order to use the charts. This is particularly true for most home consumers, who do not typically weigh their food and may not even own a kitchen scale. In addition, the food items may be cooked using barbecue grills or smokers when tailgating or camping, making it even more inconvenient and unlikely that the weight of the item can be easily determined.

In addition to charts, a number of devices have been disclosed that use methods incorporating the mass of the item to determine the cooking time of the food item. For example, U.S. Pat. No. 3,731,059 and U.S. Pat. No. 3,827,345 disclose a cooking computer for integration with a cooking apparatus. The device has means operatively associated with an input means to cook the meat item at a predetermined and substantially constant cooking temperature for a period of time computed in accordance with a cooking time formula based on at least the weight setting of a meat item.

U.S. Pat. No. 6,568,848, and its continuation U.S. Pat. No. 6,811,308, disclose a wireless remote cooking thermometer system. During cooking of the meat, a display screen associated with the remote cooking thermometer system displays the current temperature of the meat and the time remaining until the meat is fully cooked in accordance with the user's selected taste preferences. However, the time remaining is not a time remaining predicted by the cooking thermometer system, but rather is a time acquired from a user and decremented by a timer unit.

Thus, there remains a need for a system that enables an operator to estimate the cooking time remaining of a food item independent of the mass of the food item and which may accurately predict the time remaining without a constant cooking chamber temperature.

### SUMMARY OF THE INVENTION

An embodiment of a method for estimating the time for the internal temperature of an object to reach a desired temperature includes determining a temperature ratio, the temperature ratio including a relationship between a change of internal temperature of the object from an initial temperature to a temperature measured at an elapsed time and the total internal temperature change needed to reach a reference temperature. The method may further include estimating a time remaining for the internal temperature to reach the reference temperature based on a function of the temperature ratio and a time ratio, the time ratio being a relationship between the elapsed time and the total time change for the internal temperature of the object to reach the reference temperature.

An embodiment of a system for estimating the time for the internal temperature of an object to reach a desired temperature includes a controller. The controller can be configured to determine a temperature ratio, the temperature ratio including a relationship between a change of internal temperature of the object from an initial temperature to a temperature measured at an elapsed time and the total internal temperature change needed to reach a reference temperature. The controller can be further configured to estimate a time remaining for the internal temperature to reach the reference temperature based on a function of the temperature ratio and a time ratio, the time ratio being a relationship between the elapsed time and the total time change for the internal temperature of the object to reach the reference temperature.

One embodiment of a system for estimating the time for the internal temperature of an object to reach a desired temperature includes means for determining a temperature ratio, the temperature ratio including a relationship between (1) a change of internal temperature of the object from an initial temperature to a temperature measured at an elapsed time and (2) the total internal temperature change needed to reach a reference temperature. The system may further include means for estimating a time remaining for the internal temperature to reach the reference temperature based on a function of the temperature ratio and a time ratio, the time ratio being a relationship between the elapsed time and the total time change for the internal temperature of the object to reach the reference temperature.

An embodiment of a system for predictive cooking includes a temperature probe, a timer, a display and a controller. The temperature probe includes a portion configured to measure an internal temperature of a food item. The timer is configured to track an elapsed time. The display is for indicating a predicted time for a future internal temperature of a food item to reach a desired temperature. The controller is configured to receive a signal representing a measurement of the internal temperature of the food from the temperature probe and determine a temperature ratio, the temperature ratio including a relationship between a change of internal temperature of the food item from an initial temperature to a temperature measured at an elapsed time and the total internal temperature change needed to reach a reference temperature. The controller is further configured to estimate a time remaining for the internal temperature to reach the reference temperature based on a function of the temperature ratio and a time ratio, the time ratio being a relationship between the elapsed time and the total time change for the internal temperature of the food item to reach the reference temperature.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

Many aspects of systems and methods for the prediction of cooking time can be better understood with reference to the following drawings. The components in the drawings are not necessarily to scale relative to each other, emphasis instead being placed upon clearly illustrating the principles of the disclosed systems and methods. Like reference numerals designate corresponding parts throughout the several views.

FIG. 1 depicts an embodiment of a system for predicting the time to change the temperature of an object.

FIG. 2 is a block diagram depicting an embodiment of the control unit of the system of FIG. 1.

FIG. 3 is a diagram depicting traces, derived from empirical testing, that represent the change of the internal temperature of a number of objects with respect to time while the objects are heated.

FIG. 4 is a percent temperature-time chart depicting the traces of FIG. 3, reflecting a percent increase of the internal temperature of the object with respect to the percent of time to reach the reference temperature while being heated in a cooking chamber.

FIG. 5 is a percent temperature-time chart depicting a function, derived from the empirical data represented in the traces of FIGS. 3 and 4, that can be used by the system of FIG. 1 to estimate the total time to heat an object, such as a food item, to a desired temperature.

FIG. 6 is a percent temperature-time chart depicting the traces of FIG. 4 over an initial duration.

FIG. 7 is a percent temperature-time chart depicting the function of FIG. 5 represented by a plurality of linear equations that can be sequentially solved by the system of FIG. 1 to estimate a total heating time.

FIG. 8 is a chart depicting a number of empirically derived data points that represent the actual duration of time for a number of heated objects (here, food items) to reach a specified temperature as a percentage of the total temperature change and a slope that represents the rate of temperature increase to reach the specified temperature.

FIG. 9 depicts a process for detecting and/or indicating an error while heating an object.

### DETAILED DESCRIPTION

Systems and methods for predicting the time to change the temperature of an object are disclosed. Although the described systems and methods may be particularly described with respect to heating a food item to a desired temperature (i.e. cooking), the disclosed systems and methods can be useful in predicting the remaining time for heating a wide variety of gases, liquids, and/or solids to a desired temperature. Thus, it should be understood that the principles can be applied to a wide variety of other applications in which it may be useful to predict the total time and/or time remaining to heat an object to a desired temperature. As will become apparent, the disclosed systems and methods are particularly advantageous when the physical characteristics (i.e. size, shape, mass, etc.) of the object being heated is unknown and/or when the environment around the object being heated can not be maintained at a constant temperature.

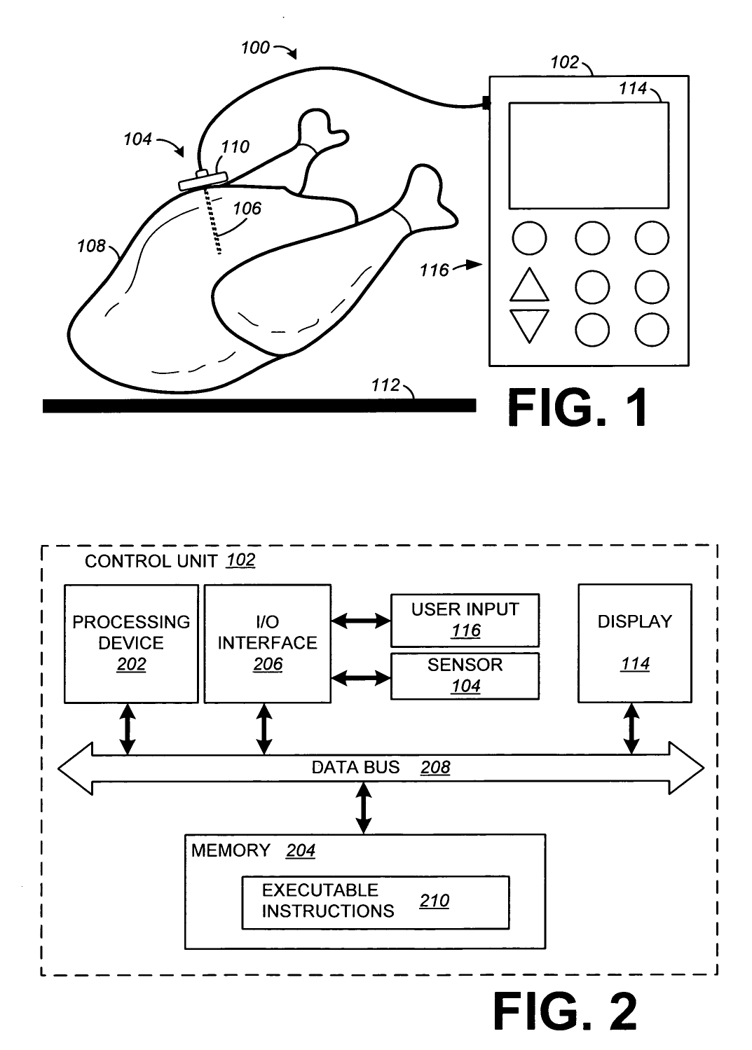

FIG. 1 depicts an embodiment of a predictive cooking system 100. The predictive cooking system generally includes a control unit 102 and a remote temperature sensing portion 104. Sensing portion 104 may include an internal temperature sensor 106 for measuring the internal temperature of an object, such as food item 108. Sensing portion 104 may also include an external temperature sensor 110 for measuring the temperature of the environment surrounding the outside of the food item 108, such as the temperature of the air inside a cooking chamber of a cooking apparatus, such as an oven, barbecue grill, or smoker. The environment surrounding the food item could also be, for example, cooking oil or water.

The control unit 102 may be configured to receive signals from sensing portion 104 representing a measurement of the internal temperature of the food item and/or the temperature of the environment around the food item 108. The internal temperature sensor 106 may, for example, include a probe that can be inserted into the interior of the food item to a desired depth. Food item 108 may be meat, or any other food in which it is desirable to measure doneness in relation to the internal temperature. For example, meat is often cooked to a desired temperature that corresponds to a desired taste and/or doneness.

Although internal temperature sensor 106 and external temperature sensor 110 are depicted as being part of the same sensing portion 104, the sensors could be separate. For example, a cooking device may include an integrated temperature sensor that measures the temperature of the cooking chamber. Additionally, in some embodiments, external temperature sensor 108 may be positioned a distance closer to, or farther away from, a cooking surface 112.

Control unit 102 provides a user interface for taking user inputs and displaying controller outputs. For example, a display 114 may include a menu system for providing the user with a series of interactive screens to record the desired temperature for the food item and to indicate progress of the cooking of the food item (i.e. the current temperature, the estimated time remaining, time elapsed, etc.). Control unit 102 may include a user input 116, which may include keys, buttons, or knobs, for example. The user input may, among other purposes, be used to drive the menu system in order to input the desired temperature and indicate the beginning of the cooking cycle.

According to one embodiment, the control unit 102 may include preprogrammed internal temperatures for a type of food and desired doneness, which corresponds to the desired internal temperature. For example, if the food item selected by the user is chicken or turkey, the desired temperature may be configured to be set to 180° F. For beef, the display may request a user to input a desired taste (i.e. medium rare, medium, or well done). The selected desired taste may correspond to a desired internal temperature (i.e. 145° F., 160° F., or 170° F., respectively). According to some embodiments, the control unit may be configured to allow a user to input the desired internal temperature directly.

After the unit has been programmed and the internal temperature sensor has been inserted into the food item, the user may indicate the start of the cooking period. During cooking, the display 114 may indicate, among other information, the current temperature of the food item and the latest predicted cooking time remaining. The predicted cooking time remaining is an estimate of the time remaining until the actual internal temperature (i.e. measured by internal temperature sensor 106) of the food item will reach the desired internal temperature. The predicted cooking time remaining may be periodically calculated by control unit 102 and updated on the display (e.g. continuously or at the request of the user). Embodiments for determining the predicted cooking time remaining are discussed in detail below.

FIG. 2 is a block diagram of an exemplary control unit 102 which may generally include the display 114, a processing device 202, memory 204, and input/output interface 206, each of which may communicate over a data bus 208. Processing device 202 may be programmed to execute instructions for predictive cooking, such as those used to receive the user input, determine the predicted cooking time, and to generate any alarms or error conditions related to the cooking cycle. Memory 204 may store the instructions used by processing device 202 and any other data to be used by processing device 202 to carry out its instructions. For example, memory 204 may store the desired internal temperature, an elapsed cooking time, and a number of internal temperature measurements recorded at the elapsed cooking times, and one or more measurements from the external temperature probe.

Input/output interface 206 may be configured to receive signals from sensor 104 and user input 116. The signals may be received and interpreted by the control unit 102 through processing device 202. According to some embodiments, input/output interface 206 may also be used to transmit and/or receive signals from a wireless remote device (not depicted). The wireless remote device can, for example, be carried by a user to a location remote from the control unit 102 and may be configured to wirelessly receive signals from the control unit 102 representing various aspects of the cooking process, such as whether the food item has completed cooking, the actual internal temperature of the food item, and/or the predicted remaining cooking time.

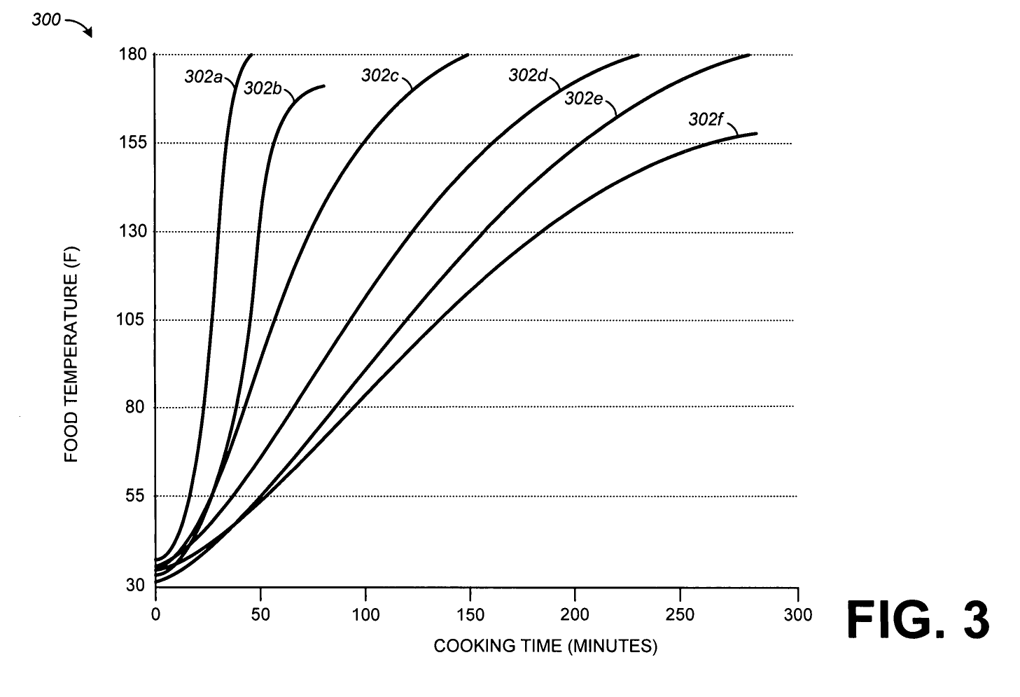

Now that the basic components of predictive cooking system 100 have been described generally, embodiments of processes for predictive cooking that can be implemented by the predictive cooking system 100 are described. FIG. 3 depicts a temperature-time diagram 300 depicting several temperature-time traces 302a-302f that represent the change of the internal temperature of a number of food items with respect to time. Traces 302a-302f correspond to a number of experimental trials carried out for the purpose of collecting empirical data. Specifically, each trace depicts the increase in temperature of a meat item while being cooked in a heated cooking chamber. The traces 302a-302f represent meat items having differing types (i.e. beef, chicken, pork, etc.), shapes, and masses. Groups of the meat items are also cooked using different average cooking chamber temperatures and also have different initial internal temperatures. The meat items were cooked in a barbecue grill, and thus were subjected to cooking chamber temperatures that could not be controlled with the degree of accuracy enabled by a conventional oven. Each of the meat items represented by traces 302a, 302b, 302c, 302d, and 302e were heated until the interior temperature reached a reference temperature of 180° F. However, as shown by their respective traces, meat items 302b and 302f were unable to reach the reference temperature of 180° F. in a reasonable amount of time. That is, their respective rate of temperature increase, which corresponds to the slope of the traces, diminished below an acceptable threshold. This could have been because, for example, the cooking temperature was not high enough for the mass or shape of the meat item.

The resulting “S” shaped temperature-time traces 302a-303f generally depict what is represented by conventional cooking charts that incorporate the mass, type, and starting temperature of a food item, along with the temperature of the cooking chamber, to determine a cooking time to reach a desired internal temperature. However, because of variations in the shape of the meat, the fluctuating temperature of the cooking chamber, and varied initial internal temperatures, the actual traces 302a-302f vary slightly from that expected from a cooking chart. Accordingly, even knowing the weight of the meat item, it can be difficult to predict the total cooking time using a conventional cooking chart. Further, without knowing (or estimating) the weight of the meat item, conventional time charts cannot be used to determine the cooking time at all.

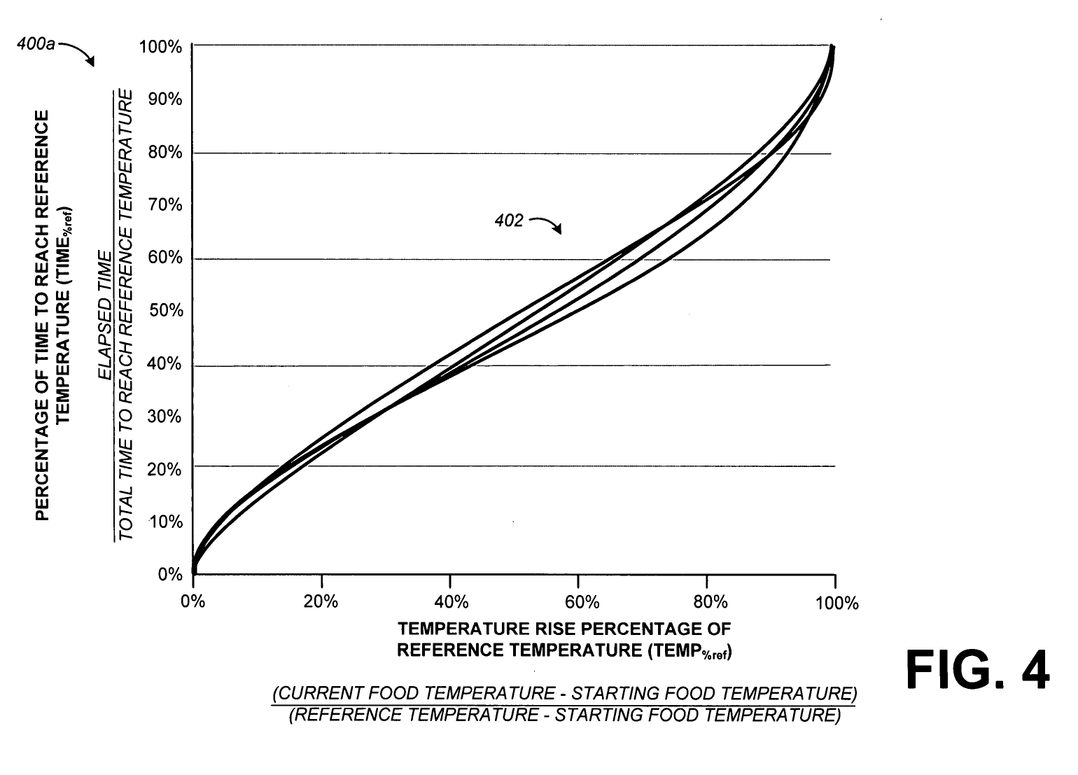

FIG. 4 depicts a graphical representation of the empirical data used to create the traces 302a, 302c, 302d, and 302e of FIG. 3, in a percent temperature-time chart 400a. Percent temperature-time chart 400a represents the percent of the required increase of the internal temperature of a meat item with respect to the total percent of time estimated to reach the reference temperature, while the meat item is cooked in the heated cooking chamber.

Thus, the empirical data used to generate time-temperature traces 302 of FIG. 3 has been used to generate the new set of percent temperature-time traces 402 depicted in FIG. 4. Specifically, the x-axis of chart 400a consists of temperature ratio values that represent the relationship between the amount that the internal temperature of the meat item has changed with respect to the reference temperature. The y-axis of chart 400a consists of time ratio values that represent the relationship between the elapsed time with respect to the total time change to reach the reference temperature.

As depicted in FIG. 4, the percent temperature-time plots 402 of each meat item follow a nearly identical trace. Accordingly, despite the different cooking chamber temperatures, different types of the meat items, different shapes of the meat items, and the different initial internal temperatures of the food items, a common relationship exists between the percent time to reach the reference temperature and the percent temperature rise to reach the reference temperature.

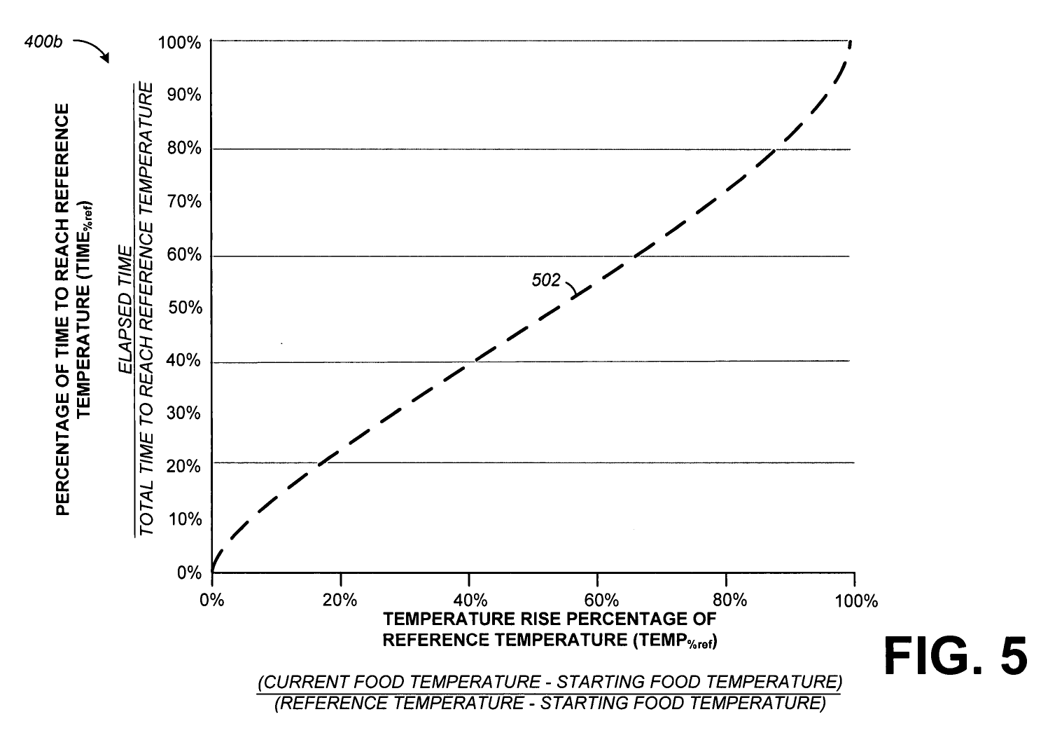

Because the percent temperature-time plots 402 follow a similar path, a function can be used to estimate the total cooking time for a food item so long as the initial internal meat temperature of the food item, the current internal temperature of the food item, and the elapsed cooking time is known. For example, the percent temperature time-plot traces 402 can be represented by a single function 502, as depicted in the percent temperature-time chart 400b of FIG. 5.

For example, the time-plot paths 402 can be averaged, a single representative curve can be selected, or the curves can be otherwise combined to form a single representative function 502. Using function 502, the total cooking time for any food item to reach the reference temperature can be estimated. Accordingly, the time estimated for the internal temperature of the meat item to reach the reference temperature can be predicted by subtracting the elapsed cooking time from the estimated total cooking time. In the case that the reference temperature is the desired temperature, the estimated remaining cooking time can be estimated directly from these calculations.

More specifically, looking at the x-axis of chart 400b, the TEMP_{% ref} is the ratio of the amount that the internal temperature of the food item has changed from its initial temperature at an elapsed time, with respect to the total temperature change needed to reach the reference temperature from the initial internal food temperature.

Accordingly, the values along the x-axis may be referenced as:
TEMP_{% ref}=(Current Change in Internal Food Temperature)/(Total Temperature Change to Reach Reference Temperature) (eq. 1)
or:
TEMP_{% ref}=(TEMPₜ−TEMP₀)/(TEMP_{ref}−TEMP₀) (eq. 2)
where:

t=the elapsed cooking time;

TEMPₜ=current internal food temperature (i.e. at elapsed time “t”);

TEMP₀=initial internal food temperature (i.e. at initial time “0”); and

TEMP_{ref}=reference temperature.

The values along the y-axis represent the ratio (TIME_{% ref}) of the elapsed time with respect to the change in time to reach the reference temperature. Values along the y-axis may be referenced as:
TIME_{% ref}=(Elapsed Time)/(Total Time to Reach the Reference Temperature) (eq. 3)
or:
TIME_{% ref}=(TIME_{elapsed})/(TIMEₜₒₜ) (eq. 4)
where:

TIME_{elapsed}=elapsed cooking time; and

TIMEₜₒₜ=total time estimate to reach the reference temperature.

Accordingly, because the values for TEMPₜ, TEMP₀, TEMP_{ref} and TIME_{elapsed} are known, TIMEₜₒₜ can be solved for using function 502. Once TIMEₜₒₜ is calculated, the remaining time can be determined by the equation:
TIMEᵣₑₘ=TIMEₜₒₜ−TIME_{elapsed} (eq. 5)
where TIMEᵣₑₘ is the predicted time remaining until the internal temperature is equal to the reference temperature.

Accordingly, in the case that the reference temperature is the desired internal temperature, the predicted time remaining can then be displayed to the user. Although different functions can be generated (i.e. from empirical testing) and used for respective reference temperatures, according to some embodiments the estimated time to reach a desired internal temperature can be calculated without the need for further empirical testing. Such embodiments will be described in more detail in later portions of this disclosure.

In the case that the reference temperature is the desired internal temperature, the predicted time remaining can then be displayed to the user as the predicted cooking time remaining. The predicted time remaining may be updated from time to time, and this updated time may be depicted in the display 114. For example, the cooking time remaining may be updated as the elapsed time changes and/or as the value for TIMEₜₒₜ is updated. For example, TIMEₜₒₜ may be updated periodically or at desired events (e.g. at the request of a user).

In practice, the predicted time remaining may become increasingly more accurate as the actual internal temperature converges to the reference temperature. Thus, it may be desirable to display the predicted cooking time remaining only after a selected period of time or other minimum threshold. For example, the cooking time remaining may be displayed to the user once the TEMP_{% ref} value meets or exceeds a threshold value.

According to some embodiments, the predicted time can be displayed once the ratio of the amount of the internal temperature with respect to the total temperature change to reach the reference temperature reaches 12.5% (i.e. when TEMP_{% ref}=12.5%). Thus, the actual duration of time until the predicted cooking time is displayed may vary depending on, for example, the physical characteristics of the food item and/or the temperature of the cooking chamber.

According to some embodiments, rather than relying on only a single function (e.g. using function 502) for every cooking session, the predicted cooking time may be calculated based on one or more of a plurality of potential functions that are selected based on, for example, the cooking characteristics during an initial period of time. Thus, according to one embodiment, a first function can be selected for an initial duration of time, and then adjusted for the remainder of the cooking process based on the cooking characteristics during the initial duration.

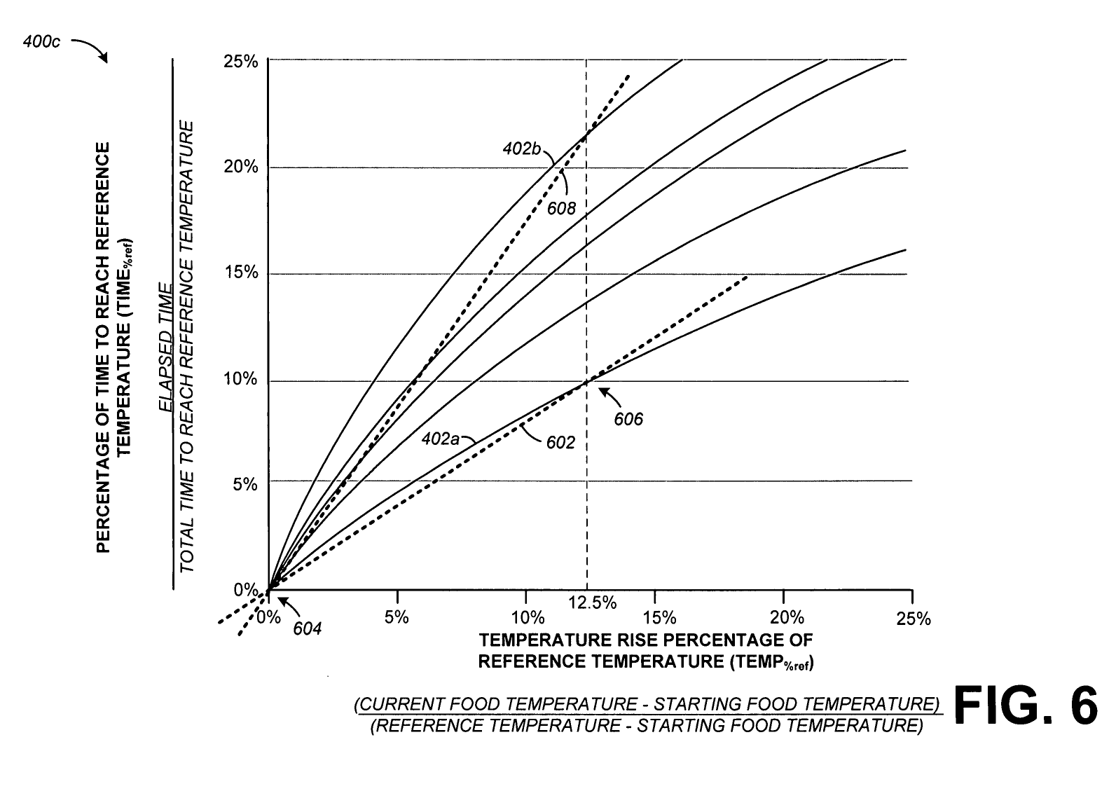

For example, chart 400c of FIG. 6 depicts the traces 402 of chart 400a over an initial duration. According to such an embodiment, the duration may represent the time it takes for TEMP_{% ref} to reach a predetermined ratio (here, 12.5%). Based on the rate of temperature rise of the food item during the initial cooking period, a function can be selected for predicting the remaining cooking time over subsequent time periods. That is, a new function (e.g. represented by a percent time-temperature curve 502) can be selected based on the rate of temperature rise of the food item during the initial cooking period.

For trace 402a, the rate of temperature rise can be determined by measuring the slope of line 602, which runs through the origin 604 of the chart and the point 606 at which TEMP_{% ref} reaches the predetermined ratio. Similarly, for trace 402b, the rate of temperature rise can be determined from the slope of line 608.

The slope may then be used to select an appropriate function for estimating TIMEₜₒₜ for a subsequent period of time after TIME_{% ref} reaches the predetermined ratio. For example, a table may hold a number of functions that correspond to a range of possible slopes. A respective function may then be selected from the table based on the actual slope. The selected function can then be used to determine TIMEₜₒₜ and the estimated time remaining to reach the reference temperature.

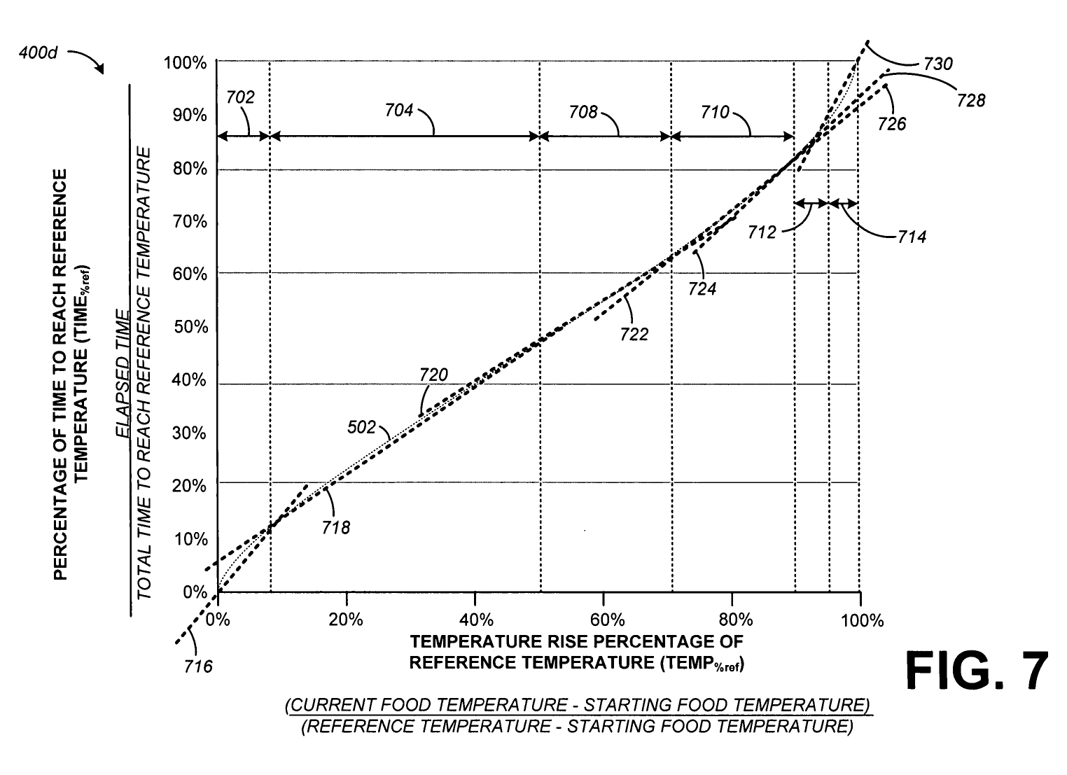

According to some embodiments, this initial temperature-rise slope can be used to generate a set of one or more equations that can be used as function 502. For example, looking to FIG. 7, chart 400d depicts chart 400b as being divided into a plurality of sections 702-714. Each section 702-714 represents a range of the TEMP % ref values. According to the embodiment depicted in chart 400d, section 702 represents the portion of TEMP_{% ref} between 0 and 12.5%, section 704 represents the portion of TEMP_{% ref} between 12.5% and 50%, section 708 represents the portion of TEMP_{% ref} between 50% and 75%, section 710 represents the portion of TEMP_{% ref} between 75% and 87.5%, section 712 represents the portion of TEMP_{% ref} between 87.5% and 97%, and section 714 represents the portion of TEMP_{% ref} between 97% and 100%.

Function 502 can then be represented by breaking the function into a set of equations, each equation corresponding to one of the respective sections 702-714. For example, line 716 represents the portion of function 502 in section 702. Line 718 represents the portion of the function 502 in section 704, and so forth. Accordingly, linear equations can be used to solve for values along each of lines 716-730. These equations can then be solved for TIMEₜₒₜ (and eventually TIMEᵣₑₘ using equation 5).

For example, an exemplary equation set may be represented by table 1, where X is the slope of line 716:

TABLE 1

| TEMP_{%ref} | EQUATION | Eq. # |
|---|---|---|
| TEMP_{%ref} = 12.5% | TIME_{%ref} = X * (TEMP_{%ref}) | (eq. 6) |
| 12.5% < TEMP_{%ref} < 50% | TIME_{%ref} = 0.64*(TEMP_{%ref}) + | (eq. 7) |
| | (0.1423*X − 0.0961) | |
| 50% < TEMP_{%ref} < 75% | TIME_{%ref} = 0.79*(TEMP_{%ref}) + | (eq. 8) |
| | (0.1309*X − 0.1516) | |
| 75% < TEMP_{%ref} < 87.5% | TIME_{%ref} = 1.08*(TEMP_{%ref}) + | (eq. 9) |
| | (0.0546*X − 0.2537) | |
| 87.5% < TEMP_{%ref} < 97% | TIME_{%ref} = 1.5 * (TEMP_{%ref}) + | (eq. 10) |
| | (0.0434*X − 0.5912) | |
| 97% < TEMP_{%ref} ≦ 100% | TIME_{%ref} = 2 * (TEMP_{%ref}) − 1 | (eq. 11) |

Here, no predicted time is calculated until TEMP_{% ref} reaches at least 12.5%. At that time, the slope X of line 716 is recorded, and equation 6 can be used to determine TIME_{% ref}. As discussed above, slope X represents the measured rate of temperature rise of the food item during the initial cooking period (i.e. where TEMP_{% ref}=0-12.5%). Once the slope X is determined, the value can be used in some, or all, of the remaining equations in the equation set. Here, the slope X affects the position of the y-intercept in each of equations 7-10. Because the y-intercept determines the value for TEMP_{% ref}, a relationship exists between TEMP_{% ref}, the total predicted time (TIMEₜₒₜ), and the time elapsed (TIME_{elapsed}), as is apparent from equation 4.

Accordingly, the rate of temperature rise of the food item during the initial cooking period has a relationship to the total predicted time (TIMEₜₒₜ) to cook the food item, as has been observed from empirical testing. Accordingly, in that the value for TIME_{elapsed} is known and the value of TEMP_{% ref} can be solved from equations 6-11, the following equation 12 can be used to solve for the total cooking time.
TIMEₜₒₜ=(TIME_{elapsed})/(TEMP_{% ref}) (eq. 12)

It should be understood that the specific equations of table 1, used to represent the function 502, were determined empirically. Further empirical testing under varying conditions (cooking temperature, initial temperature, types of food, etc.) could result in a change to the equations without departing from the spirit and scope of the invention.

Although each section 702-714 could have a number of different equations based on the rate of temperature change during the initial period of time, the exemplary equation set of table 1 has been simplified to associate only a single equation for each section 702-714. For example, the portions of the function 502 (e.g. the equations that correspond to lines 716-730) were observed to have nearly identical slopes across the sections 702-714, regardless of the rate of temperature change during the initial period of time. However, the y-intercept was observed to change in relation to the rate of temperature change during the initial period. Accordingly, the rate of temperature change during the initial cooking period is used to vary the y-intercept of equations 6-11 while using a fixed, representative slope.

According to some embodiments, the function 502 can be further refined based on a physical reading of the cooking environment, such as the temperature of the cooking chamber. For example, control unit 102 may take a reading using external temperature sensor 110 at a desired time and use this temperature reading of the cooking chamber as another factor in determining the remaining time (TIMEₜₒₜ). Relatively low cooking temperatures slow the cooking process, while relatively high cooking temperatures hasten the cooking process. Thus, according to one example, the value used for slope X in equations 6-11 can be altered based on the temperature of the grill at the end of the initial time period using the following equation:
X=((0.0001*(TEMPₑₙᵥ)−0.0086)*(TIME_{elapsed})+0.6754) (eq. 13)
where TEMPₑₙᵥ=temperature of the environment at the end of the initial duration (i.e. when TEMP_{% ref}=12.5%). Once the value for X is determined, this value can then be used when calculating TIME % ref from each of equations 6-11. The derivation of equation 13 is explained below.

It should be understood that determining the initial slope X of any given food item is necessarily a process of estimation. That is, although the TEMP_{% ref} can be determined (since the values of the initial cooking temperature, the current food temperature, and the desired food temperature are known), the actual total time TIMEₜₒₜ can not be determined until the internal temperature of the food item has reached the desired temperature. Thus, TIMEₜₒₜ is only an estimation until the actual internal temperature of the food item reaches the desired internal temperature.

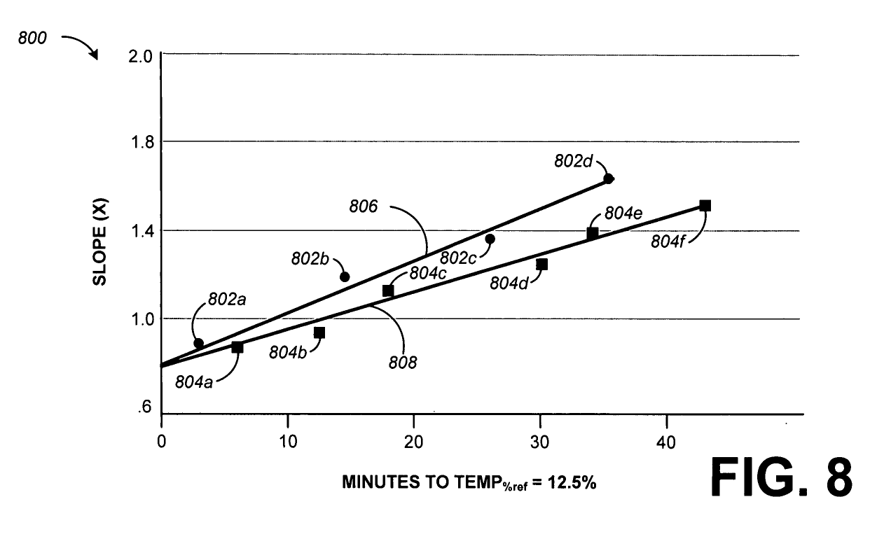

However, using empirical data, a relationship was found to exist between the time it takes food items cooked at a particular temperature to reach a TEMP_{% ref} of 12.5%. For example, FIG. 8 is a graph 800 depicting a number of data points representing the actual time it took for a number of food items to reach a TEMP_{% ref} of 12.5%. Data points 802a-802d (depicted as solid circles) represent data collected from food items cooked at a temperature of 375°, while data points 804a-804f (depicted as solid squares) represent data collected from food items cooked at a temperature of 260°.

The x-axis of graph 800 represents the total minutes it actually took for the respective food items to reach a TEMP_{% ref} representing 12.5% complete. The y-axis of graph 800 represents the average slope of the trace of the respective food items to reach a TEMP_{% ref} representing 12.5% complete. That is, the values along the y-axis represent the rate of temperature increase during the initial duration.

Accordingly, line 806 represents a relationship between points 802a-802d, and line 806 represents a relationship between points 804a-804f. Thus, for other food items cooked at a similar temperature, these relationships can be used to estimate the time that a respective food item will reach a TEMP_{% ref} of 12.5% complete. For example, the equation:
y=0.0119*x+0.675 (eq. 14)
which corresponds to line 806, can be used to estimate a slope X for items cooked at a temperature of 375°. That is, since the duration of time to reach 12.5% of the reference temperature can be determined, the equation can be solved for y. This value corresponds to the estimated slope X in equations 6-10.

The same methodology can be used to determine an estimated slope X for food items cooked at 260° using the following equation:
y=(0.0325)x+0.675 (eq. 15)
which corresponds to line 808.

Thus, according to some embodiments, a temperature reading of the cooking environment can be used in estimating the remaining cooking time. By incorporating the temperature reading of the cooking environment into the determination of the estimated slope X, a more accurate total time prediction can result. However, according to some embodiments, it is not necessary to measure and use the cooking temperature. For example, a cooking temperature can be assumed, a fixed estimated slope X can be used, and/or a single one of equations 14 or 15 can be used regardless of the actual temperature of the cooking environment. Using further empirical testing it is possible to determine relationships for other cooking temperatures as well, or such information could be interpolated from existing data. For example, assuming a linear relationship between the slope X and the cooking temperature, the slope X of any cooking temperature can be estimated. Using the above examples, the slope X at 260° is approximately 0.0199, and the slope X at 375° is 0.0325. Accordingly, the following equation can be used to interpolate slope values for a wide range of cooking environment temperatures:
y=(0.0001)x−0.0086 (eq. 16)
where x is any measured temperature and solving for y provides the estimated slope X.

In that the y-intercepts of equations 14 and 15 are nearly identical, a single equation can be generated to estimate the initial slope X for any given measured cooking temperature by incorporating equation 16 into equation 13. For example,
X=(0.0001*(COOKTEMP)−0.0086)*(TIME_{elapsed})+0.6754) (eq. 17)
where COOKTEMP is the measured temperature of the cooking chamber when TEMP_{% ref} is 12.5%. Based on X, equations 6-11 can be used to estimate the TIME_{% ref} and the estimated cooking time remaining using equation 5.

Although, the exemplary equations used in the embodiments described thus far are based on a reference temperature of 180°, the formulas can be modified to determine the remaining time for the internal temperature of the food item to reach any desired cooking temperature. Such modifications use the same principles and do not require additional empirical testing to generate new functions.

For example, according to some embodiments, the time to reach a desired temperature can be estimated based on a relationship between the total change in temperature to reach 180° and the total change in temperature to reach the desired temperature. For example, such a relationship can be based on the following formula:
% REFTEMP=(TEMP_{target}−TEMP₀)/(TEMP_{ref}−TEMP₀) (eq. 18)
where TEMP_{target} is the desired (i.e. target) temperature, TEMP₀ is the initial internal food temperature, and TEMP_{ref} is the reference temperature. TEMP_{ref} can be, for example, the 180° value used in the embodiments above. The 180° reference temperature is selected here, for example, because it is typically the highest internal temperature that is used for cooking meat items.

By substituting the value of % REFTEMP for the TEMP_{ref} in equations 6-11 of table 1, a new set of equations used for determining a total cooking time modifier (TIMEMOD) can be calculated. The cooking time modifier provides a factor which can be used to appropriately scale the value of TEMP_{% ref} calculated using the equations of table 1 to determine the cooking time remaining to the desired cooking temperature (instead of merely the reference temperature). Accordingly, the following respective equations 19-24 in table 2 can be generated and used to solve for the value of TIMEMOD:

TABLE 2

| %REFTEMP | EQUATION | Eq. # |
|---|---|---|
| %REFTEMP = 12.5% | TIMEMOD = X * %REFTEMP | (eq. 19) |
| 12.5% < %REFTEMP < | TIMEMOD = 0.64 * %REFTEMP + | (eq. 20) |
| 50% | (0.1423*X − 0.0961) | |
| 50% < %REFTEMP < | TIMEMOD = 0.79 * %REFTEMP + | (eq. 21) |
| 75% | (0.1309*X − 0.1516) | |
| 75% < %REFTEMP < | TIMEMOD = 1.08 * %REFTEMP + | (eq. 22) |
| 87.5% | (0.0546*X − 0.2537) | |
| 87.5% < %REFTEMP < | TIMEMOD = 1.5 * %REFTEMP + | (eq. 23) |
| 97% | (0.0434*X − 0.5912) | |
| 97% < %REFTEMP ≦ | TIMEMOD = 2 * %REFTEMP − 1 | (eq. 24) |
| 100% | | |

According to this embodiment, despite the similar ranges for % REFTEMP of table 2 and the ranges for TEMP_{% ref} of table 1, it should be apparent that the percentage value for % REFTEMP is fixed and does not change. Thus, once the desired target internal temperature (TEMP_{target}) and initial temperature (TEMP₀) is known, both the value of % REFTEMP and the resulting value of TIMEMOD generated from the respective equation of table 2 is fixed throughout the cooking process.

Once TIMEMOD is calculated, the following equations can be used to determine the total estimated cooking time to reach the desired temperature:
TIMEₜₒₜ=((TIME_{elapsed})/(TEMP_{% ref}))*(TIMEMOD) (eq. 25)
where TEMP_{% ref} is calculated using the appropriate equation from table 1 (depending on the current value of TEMP_{% ref}) and TIMEMOD is generated based on the appropriate equation from table 2. Using equation 5, the cooking time remaining (TIMEᵣₑₘ) can then be estimated by subtracting the total cooking time from the elapsed time. Accordingly, the equations of tables 1 and 2 can be combined to estimate the total cooking time for a variety of desired temperatures without the need for additional empirical testing.

Now that the general overview of the methods for predicting the remaining cooking time have been described, a method for detecting and indicating an error during the heating of a food item is described. As best depicted by the traces 302b and 302e of FIG. 3, food items being heated may never reach the desired temperature, or the duration of time to arrive at the desired cooking temperature can be undesirably long. Such an occurrence may happen, for example, if the temperature of the cooking environment is too low and/or the food item is too large for the given cooking temperature. In these situations it can be beneficial to provide an indication of such a condition, such as through a visible or audible alarm.

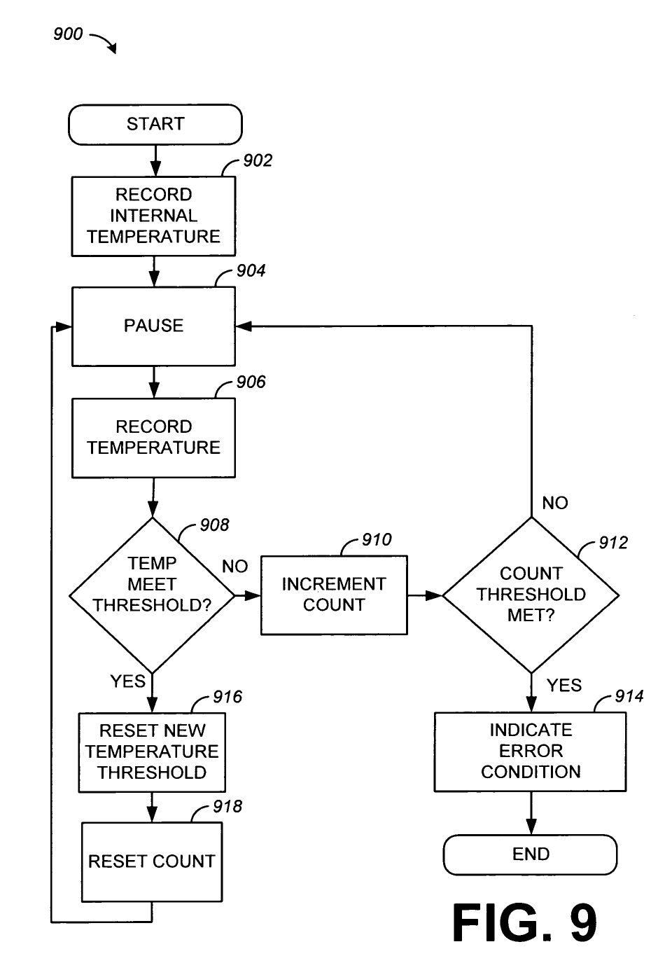

FIG. 9 depicts an embodiment of a process 900 for detecting and/or indicating an error during the heating of a food item. In general, the process can indicate an error if the internal temperature of the food item does not increase at a desired rate. A counter is incremented each time a successive temperature reading fails to increase over a predetermined temperature threshold. Upon meeting the threshold temperature, the counter is reset, a new threshold temperature is determined, and the process continues. However, if the counter value reaches a counter threshold value, an error can be indicated. Because the temperature readings can be performed on a regular basis (i.e. once a second, etc.) and the temperature threshold is known, the process can be used to indicate whether the internal food temperature is increasing at the desired rate (i.e. 2 degrees/minute, etc.).

More specifically, looking to FIG. 9, at block 902 a reading of the internal temperature of a food item can be recorded and stored in memory. At block 904, the process may include pausing for a duration of time before taking another internal temperature reading of the food item at block 906. The internal temperature reading recorded at block 906 can be stored in memory and a differential between the internal temperature reading from block 902 and the internal temperature reading of block 906 can be calculated. At block 908, the temperature differential can be compared to a threshold temperature change value.

If the temperature differential is not equal to or greater than the threshold temperature change value (the NO condition), a counter is incremented at block 910. At block 912, the value of the counter is compared to a counter threshold value. If the counter has met or exceeded the threshold value (the YES condition), the internal temperature of the food item has not increased at the desired rate. Accordingly, at block 914 an error can be indicated. For example, a visual indicator may appear on display 114 or, assuming that the control unit 102 is equipped with a speaker, an audio signal may be emitted. However, if the counter has not met the threshold value (the NO condition of block 912) the process can delay for another interval at block 904 before taking yet another internal temperature reading at block 906.

Blocks 904, 906, 908, 910 and 912 are repeated until the counter reaches the counter threshold to indicate an error condition, or until the internal temperature of the food item increases over the threshold (the YES condition of block 908). If the temperature increases over the threshold, a new temperature threshold is set at block 916, the counter is reset to zero at block 918, and the process continues again at block 904. The process continues as described above until an error condition is met at block 912 or the cooking process ends.

Because the rate of temperature increase varies over the cooking process, the temperature threshold value used and/or the count threshold can be varied accordingly. For example, according to the empirical test results depicted in FIG. 3, the rate of temperature increase of each trace 302a-302f is initially high, then is maintained relatively constant throughout the majority of the cooking process, and finally begins to be reduced as the internal temperature of the food item converges with the reference temperature at the end of the cooking process. Thus, the threshold value for the rate of temperature increase and/or the counter may change corresponding to the ratio of the actual internal temperature of the food item and the desired internal temperature of the food item. For example, by increasing the value of the count threshold the internal temperature of the food is allowed to increase more slowly before indicating an error.

It should be understood that any of the methods or processing described herein could be implemented within hardware, software, or any combination thereof. For example, when processing or process steps are implemented in software, it should be noted that such steps to perform the processing can be stored on any computer-readable medium for use by, or in connection with, any computer-related system or method. In the context of this document, a computer-readable medium is an electronic, magnetic, optical, or other physical device or means that can contain or store a computer program for use by, or in connection with, a computer related system or method. The methods can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In some embodiments, where the processing is implemented in hardware, the underlying methods can be implemented with any, or a combination of, the following technologies, which are each well known in the art: (a) discrete logic circuit(s) having logic gates for implementing logic functions upon data signals, an application-specific integrated circuit (ASIC) having appropriate combinational logic gates, (a) programmable gate array(s) (PGA), a field programmable gate array (FPGA), etc; or can be implemented with other technologies now known or later developed.

Any process descriptions, steps, or blocks in flow diagrams should be understood as potentially representing modules, segments, or portions of code which include one or more executable instructions for implementing specific logical functions or steps in the process, and alternate implementations are included within the scope of the preferred embodiments of the methods in which functions may be executed out of order from that shown or discussed, including substantially concurrently or in reverse order, depending on the functionality involved, as would be understood by those reasonably skilled in the art.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A method for estimating the time for the internal temperature of an object to reach a desired temperature, comprising:
determining a temperature ratio, the temperature ratio including a relationship between (1) a change of internal temperature of the object from an initial temperature to a temperature measured at an elapsed time and (2) the total internal temperature change needed to reach a reference temperature; and
estimating a time remaining for the internal temperature to reach the reference temperature based on a function of the temperature ratio and a time ratio, the time ratio being a relationship between the elapsed time and the total time change for the internal temperature of the object to reach the reference temperature.

2. The method of claim 1, further comprising:
estimating the time for the internal temperature of the object to reach the reference temperature by taking the difference between the elapsed time and an estimated total time for the internal temperature of the object to reach the reference temperature.

3. The method of claim 1, wherein the reference temperature is the desired internal temperature of the object.

4. The method of claim 1, wherein the method further includes:
estimating the time for the internal temperature of the object to reach the reference temperature based on a rate of temperature rise of the object during an initial period.

5. The method of claim 4, further comprising:
receiving a temperature measurement of the environment outside of the object; and
estimating the time for the internal temperature of the object to reach the reference temperature based on the temperature measurement of the environment outside of the object.

6. The method of claim 1, further comprising:
storing a plurality of internal temperature measurements of the object over a duration of time; and
generating an error if a rate of temperature change of the plurality of internal temperature measurements over the duration of time is below a temperature rate change threshold.

7. The method of claim 1, wherein the desired temperature is different from the reference temperature and the method further comprises:
determining a reference temperature ratio, the reference temperature ratio including a relationship between (1) the total change of the internal temperature of the object from the initial temperature needed to reach the desired temperature and (2) the total change of the internal temperature change needed to reach the reference temperature; and
estimating the time to heat the object to the desired temperature using a relationship between the temperature ratio and the reference temperature ratio.

8. A system for estimating the time for the internal temperature of an object to reach a desired temperature, comprising:
a controller configured to:
determine a temperature ratio, the temperature ratio including a relationship between (1) a change of internal temperature of the object from an initial temperature to a temperature measured at an elapsed time and (2) the total internal temperature change needed to reach a reference temperature; and
estimate a time remaining for the internal temperature to reach the reference temperature based on a function of the temperature ratio and a time ratio, the time ratio being a relationship between the elapsed time and the total time change for the internal temperature of the object to reach the reference temperature.

9. The system of claim 8, wherein the controller is further configured to:
estimate the time for the internal temperature of the object to reach the reference temperature by taking the difference between the elapsed time and an estimated total time for the internal temperature of the object to reach the reference temperature.

10. The system of claim 8, wherein the reference temperature is the desired internal temperature of the object.

11. The system of claim 8, wherein the desired temperature is different from the reference temperature and the controller is further configured to:
determine a reference temperature ratio, the reference temperature ratio including a relationship between (1) the total change of the internal temperature of the object from the initial temperature needed to reach the desired temperature and (2) the total change of the internal temperature change needed to reach the reference temperature; and
estimate the time to heat the object to the desired temperature using a relationship between the temperature ratio and the reference temperature ratio.

12. The system of claim 8, wherein the controller is further configured to:
estimate the time for the internal temperature of the object to reach the reference temperature based on a rate of temperature rise of the object during an initial period.

13. The system of claim 12, wherein the controller is further configured to:
receive a temperature measurement of the environment outside of the object; and
estimate the time for the internal temperature of the object to reach the reference temperature based on the temperature measurement of the environment outside of the object.

14. The system of claim 8, wherein the controller is further configured to:
store a plurality of internal temperature measurements of the object over a duration of time; and
generate an error if a rate of temperature change of the plurality of internal temperature measurements over the duration of time is below a temperature rate change threshold.

15. The system of claim 8, wherein the system further includes a display for indicating an error upon the controller determining that the rate of change of the plurality of internal temperature measurements is below the temperature rate change threshold.

16. A system for estimating the time for the internal temperature of an object to reach a desired temperature, comprising:
means for determining a temperature ratio, the temperature ratio including a relationship between (1) a change of internal temperature of the object from an initial temperature to a temperature measured at an elapsed time and (2) the total internal temperature change needed to reach a reference temperature; and
means for estimating a time remaining for the internal temperature to reach the reference temperature based on a function of the temperature ratio and a time ratio, the time ratio being a relationship between the elapsed time and the total time change for the internal temperature of the object to reach the reference temperature.

17. The system of claim 16, further comprising:
means for estimating the time for the internal temperature of the object to reach the reference temperature by taking the difference between the elapsed time and an estimated total time for the internal temperature of the object to reach the reference temperature.

18. The system of claim 16, wherein the reference temperature is the desired internal temperature of the object.

19. The system of claim 16, wherein the method further includes:
means for estimating the time for the internal temperature of the object to reach the reference temperature based on a rate of temperature rise of the object during an initial period.

20. The system of claim 19, further comprising:
means for receiving a temperature measurement of the environment outside of the object; and
means for estimating the time for the internal temperature of the object to reach the reference temperature based on the temperature measurement of the environment outside of the object.

21. The system of claim 16, further comprising:
means for storing a plurality of internal temperature measurements of the object over a duration of time; and
means for generating an error if a rate of temperature change of the plurality of internal temperature measurements over the duration of time is below a temperature rate change threshold.

22. The system of claim 16, wherein the desired temperature is different from the reference temperature and the method further comprises:
means for determining a reference temperature ratio, the reference temperature ratio including a relationship between (1) the total change of the internal temperature of the object from the initial temperature needed to reach the desired temperature and (2) the total change of the internal temperature change needed to reach the reference temperature; and
means for estimating the time to heat the object to the desired temperature using a relationship between the temperature ratio and the reference temperature ratio.

23. A system for predictive cooking comprising:
a temperature probe having a portion configured to measure an internal temperature of a food item;
a timer configured to track an elapsed time;
a display for indicating a predicted time for a future internal temperature of a food item to reach a desired temperature; and
a controller configured to:
receive a signal representing a measurement of the internal temperature of the food from the temperature probe;
determine a temperature ratio, the temperature ratio including a relationship between (1) a change of internal temperature of the food item from an initial temperature to a temperature measured at an elapsed time and (2) the total internal temperature change needed to reach a reference temperature; and
estimate a time remaining for the internal temperature to reach the reference temperature based on a function of the temperature ratio and a time ratio, the time ratio being a relationship between the elapsed time and the total time change for the internal temperature of the food item to reach the reference temperature.
